(19) United States
(12) Patent Application Publication
(10) Pub. No.: US 2026/0156533 A1
(43) Pub. Date: Jun. 4, 2026

(54) MULTI-SUBFLOW PARALLEL FORWARDING AND SCHEDULING METHOD FOR NEXT-GENERATION INTELLIGENT COMPUTING CENTER NETWORKS

(71) Applicant: Nanjing University of Aeronautics and Astronautics, Jiangsu (CN)

(72) Inventors: Qiang WU, Jiangsu (CN); Haoyong YU, Jiangsu (CN); Siyang SUN, Jiangsu (CN); Ran WANG, Jiangsu (CN); Meng YUAN, Jiangsu (CN)

(73) Assignee: Nanjing University of Aeronautics and Astronautics, Jiangsu (CN)

(21) Appl. No.: 19/224,910

(22) Filed: Jun. 2, 2025

(30) Foreign Application Priority Data
Dec. 3, 2024 (CN) 202411755635.2

(51) Int. Cl. H04W 28/10

(52) U.S. Cl. CPC H04W 28/10

(57) ABSTRACT

The present disclosure discloses a method for multi-subflow parallel forwarding and scheduling in a new intelligent computing center network. The entire communication forwarding process is divided into three stages: data flow segmentation and distribution, parallel transmission, and receiving terminal sorting and reassembly. By taking the cooperation of the segmentation and distribution strategy of the data flow at the transmitting terminal and the sorting and reassembly operation of out-of-sequence data packets at the receiving terminal into consideration, the optimal flow segmentation ratio and the corresponding optimal forwarding path are determined and mapped to a physical network to complete the multi-subflow parallel transmission. The present disclosure solves the problem of the failure of conventional network scheduling methods caused by the new features of distributed large AI model training service data flows in new intelligent computing centers such as limited number of flows and large bandwidth of a single flow.

### CROSS-REFERENCE TO RELATED APPLICATION

This application claims the priority benefit of China application serial no. 202411755635.2, filed on Dec. 3, 2024. The entirety of the above-mentioned patent application is hereby incorporated by reference herein and made a part of this specification.

### TECHNICAL FIELD

The present disclosure relates to the field of computer network data transmission technology, and in particular to a method for forwarding and scheduling based on multi-subflow parallel transmission oriented to service data flows with ultra bandwidth in new intelligent computing center networks.

### DESCRIPTION OF RELATED ART

New intelligent computing centers (NICCs) oriented to distributed large AI model training are new data centers, which deploy a high-performance distributed computing cluster to specifically serve artificial intelligence and provide powerful computing capabilities and storage resources. Conventional data centers execute a computing task by using a CPU, while an intelligent computing center network is mainly used for bearing the large AI model training service. The GPU computing power thereof has better computing performance than the CPU. In addition, in a distributed large AI model training scene, a plurality of common parallel modes such as data parallelism, model parallelism, and tensor parallelism all requires that after completing a current round of computing task, a computing node in a cluster performs a large number of collective communication operations to quickly synchronize a computation result to other nodes, so as to facilitate the next round of computing. Complex collective communication will generate a huge communication data volume, leading to a significantly increased bandwidth demand thereof for network forwarding. The intelligent computing center network is experiencing unprecedented challenges.

As the scale of the new intelligent computing centers is continuously increasing, the intelligent computing center network is oriented to the fusion of a plurality of network modalities, for example, the coexistence of network modalities such as MTN, InfiniBand, and ROCE. Different network modalities are heterogeneous, and the communication performance and features thereof are significantly different. The completion time of communication is determined by the completion time of the slowest node. A scenario in which a plurality of network modalities coexist easily causes a long tail delay problem, which slows down the task completion time. In the distributed large AI model training process, the proportion of the communication time is excessive, and the service provided by the network is difficult to match the speed of a high-performance computing resource. Consequently, a large number of computing power resources are in an idle/waiting state, thus directly affecting the parameter update and a new round of iterative computing of the large model training. The network is becoming a bottleneck that limits the training efficiency and the training effect of large models.

Different from the service traffic flow of conventional data centers, the service data flow of new intelligent computing centers is characterized by a small number of flows and a large bandwidth of a single flow. To resolve the scheduling problem of elephant flows, the solution of single-flow single-path scheduling can be summarized as follows: An elephant flow is first extracted from the data flow and then separately rerouted by comprehensively considering impact factors such as available loads and the distribution degree of large flows in the path. In a conventional data center, the above solution indeed reduces the impact of the elephant flow on network load balancing. However, to deal with the service demands for ultra-large flows of a small number in new intelligent computing centers, performing hash routing by using flows as the granularity may lead to uneven network link utilization rate and thus network congestion, greatly increasing the network forwarding delay. Another type of scheduling solution is to segment the elephant flow and complete the communication forwarding of the elephant flow in combination with a multi-path parallel transmission mode. Although existing solutions for multi-path scheduling and forwarding based on data packets as the operating unit can give play to the advantages brought by multi-path parallel transmission and effectively shorten the transmission delay, severe out-of-sequence problems of data packets may arise, which introduces an additional sorting and reassembly delay. The out-of-sequence problem is difficult to resolve, and the effect of performing multi-path parallel scheduling based on the data packet may sometimes even be inferior to the effect of a single-path solution.

In view of the discrepancy between new intelligent computing center networks and service demands, the scheduling solution of multi-path parallel transmission can make full use of the rich parallel path resources in new intelligent computing center networks. However, existing elephant flow multi-path parallel scheduling methods mainly have the following problems to be solved urgently:

1. An elephant flow usually includes a large volume of data, and these data need to be transmitted in parallel through a plurality of paths after being segmented. The selection of the granularity of elephant flow segmentation greatly affects the efficiency of multi-path parallel transmission. An excessive segmentation granularity may not make full use of the parallel transmission capability of the paths, and is more prone to cause congestion during transmission in the network, whereas an insufficient segmentation granularity may cause a severe out-of-sequence problem, increase the complexity of data processing at the receiving terminal, generate a large number of additional overheads for sorting and reassembly, and reduce the transmission efficiency. Therefore, selecting an elephant flow segmentation granularity is a key problem, and an explicit solution is urgently needed to segment elephant flows.

2. When an elephant flow is transmitted in parallel through a plurality of paths, the difference in performance such as delay and bandwidth among the paths may lead to a prolonged time for data on some paths to arrive at the receiving terminal, which causes a long tail delay and slows down the overall transmission efficiency. In addition, in an environment with great path differences, inappropriate path selection may lead to an increase in the amount of out-of-sequence data and an increase in overheads of out-of-sequence processing, which results in no improvement but a reduction in the performance of multi-path parallel transmission. In a scene where a plurality of network modalities coexist in a new intelligent computing center, how to select the optimal transmission path for a segmented elephant flow to reduce the long tail delay and alleviate data out-of-sequence is not supported by the current existing solutions.

3. Current researches on multi-path parallel scheduling methods focus on avoiding out-of-sequence problem as much as possible. However, existing solutions can never completely avoid a situation in which data packets arrive in an out-of-sequence manner. Therefore, it is crucial for the elephant flow multi-path parallel forwarding and scheduling solution to comprehensively consider the cooperation between the segmentation distribution strategy at the transmitting terminal and the sorting and reassembly solution at the receiving terminal, to balance the increase and the decrease of the parallel transmission delay on the link of the elephant flow and the sorting and reassembly delay at the receiving terminal, and to find a scheduling solution that minimizes the completion time of the elephant flow.

In conclusion, it is urgent to design a brand new and efficient scheduling mechanism for multi-path parallel forwarding based on the communication scene of ultra-large bandwidth service data flow of new intelligent computing centers.

### SUMMARY

The present disclosure is intended to provide a method for multi-subflow parallel forwarding and scheduling in a new intelligent computing center network, to resolve a problem that existing scheduling strategies cannot meet the communication demands of new intelligent computing center networks when dealing with ultra-large flows of a small number in distributed large AI model training.

The technical solution to achieve the objective of the present disclosure is: A method for multi-subflow parallel forwarding and scheduling in a new intelligent computing center network that performs multi-subflow parallel forwarding and scheduling on a distributed large AI model training service data flow in a new intelligent computing center, including:
in a data flow segmentation and distribution stage, segmenting a service data flow, placing data packets sequentially into fixed-length containers of a preset length for later use, and allocating consecutive sequence numbers as a unique identifier to the fixed-length containers sequentially; a transmitting terminal distributing the segmented fixed-length containers to corresponding subflows in rounds based on configuration information issued by a central controller;
in a parallel transmission stage, completing the mapping of the configuration information to a physical network, selecting a path using the fixed-length container as a minimum operating unit, and selecting different subflow paths for different fixed-length containers for forwarding, so as to achieve parallel transmission using subflows as the granularity; and
in a receiving terminal sorting and reassembly stage, a receiver submitting, after each round of parallel transmission ends, out-of-sequence fixed-length containers in the buffer to an upper layer after sorting and reassembly; feeding information back to the central controller; and finally clearing a corresponding buffer space to wait for the next round of multi-subflow parallel transmission.

Further, before the communication forwarding of a current service data flow, the central controller integrates and issues the configuration information and buffer management information, specifically including:
a transmitter, after receiving a service request, uploading key information contained in the request to the central controller;
the central controller acquiring a physical network state in real time, and determining the number of subflows available for data forwarding from the transmitter to the receiver in the network and a link performance indicator corresponding to each subflow path, including a currently available physical bandwidth and a propagation delay; and
finding an optimal flow segmentation ratio of the current service data flow and a corresponding optimal forwarding path by using the acquired physical network state information as an input and taking a minimized total delay of data flow communication forwarding and a maximized network resource utilization rate as the optimization objectives, so as to achieve an optimal balance between a parallel transmission delay and a sorting and reassembly delay, and integrating the configuration information and the buffer management information for issue by a central controller to a data forwarding plane to control the parallel forwarding and scheduling.

Further, the data flow segmentation and distribution stage includes:
the transmitter segmenting the service data flow requesting communication forwarding; a transmitting terminal node recording the data packets into the fixed-length containers of the preset length to the maximum extent on the premise that the integrity of the data packets is ensured, and allocating consecutive sequence numbers as a unique identifier to the fixed-length containers sequentially; and
the transmitting terminal node determining an optimal load situation corresponding to each subflow based on the configuration information issued by the central controller after completing the segmentation operation, synchronizing the transmission completion time of multi-subflows in each round as much as possible by using the maximum number of fixed-length containers that can be accommodated in the buffer at the receiving terminal as a basic indicator, computing a total number of fixed-length containers transmitted in each round, and distributing in rounds the segmented fixed-length containers to the corresponding subflows to prepare for the parallel transmission.

Further, the parallel transmission stage includes:
scheduling all the data packets belonging to a same fixed-length container to a same subflow path for forwarding by using a segmented fixed-length container as a minimum operating unit to select a path, and ensuring that the data packets in the fixed-length containers are ordered upon arrival at the receiving terminal; mapping different fixed-length containers to the physical network based on the configuration information issued by the central controller, selecting different paths for transmission, so as to achieve multi-subflow parallel transmission.

Further, the receiving terminal sorting and reassembly stage includes:
the receiving terminal, after receiving the buffer management information issued by the central controller, allocating an independent space for a current service data flow for buffering and classifying the out-of-sequence fixed-length containers; the receiving terminal buffering the out-of-sequence fixed-length containers arriving at the receiving terminal, and creating, if a certain fixed-length container is the first fixed-length container arriving at the receiving terminal on the subflow and requiring buffering, a new buffer queue for the fixed-length container in the corresponding independent space for temporary storage; otherwise, placing the fixed-length container directly in a corresponding buffer queue for temporary storage; and performing the sorting and reassembly operation jointly when the arrival of the last fixed-length container in the same round is confirmed;
the receiver, after each round of parallel transmission ends, sorting the out-of-sequence fixed-length containers in the buffer using the sequence numbers as the keyword, submitting the out-of-sequence fixed-length containers to the upper layer after reassembly, and feeding information back to the central controller; the receiving terminal finally clearing the corresponding buffer space to wait for the next round of multi-subflow parallel transmission; and
the central controller notifying the transmitter that the next round of parallel transmission can be started until the forwarding of the entire service data flow is completed.

Further, the key information in the service request includes: a transmitting terminal node SRC, a receiving terminal node DST, an elephant flow length B, and a maximum communication delay D.

Further, a constrained multi-objective optimization algorithm is used to achieve the balance of the increase and the decrease of the parallel transmission delay and the sorting and reassembly delay, determine the optimal flow segmentation ratio of the current service data flow, and find the corresponding optimal forwarding path.

The constrained multi-objective optimization algorithm specifically includes: by randomly generating M row vectors consisting of n integers with a fixed sum S as the initial population, trying different subflow division and forwarding path matching solutions in a plurality of selection, crossover, and mutation processes, controlling results acquired after a plurality of iterations to continuously approach the optimal balance of the multi-subflow parallel transmission delay and the sorting and reassembly delay, finding the optimal flow segmentation ratio and the corresponding optimal forwarding path of the current service data flow with a minimized total communication forwarding delay and a maximized network resource utilization rate of the service data flow being the key objectives, and finally determining an optimal configuration situation of the number of the fixed-length containers loaded on each virtual subflow path.

Further, the processing method for the constraint specifically includes: defining a violation value of each individual err; computing err by err=abs(c), wherein c is a row vector satisfying c(1)=|S−Σₛ_{ᵢ}_{≠0}sᵢ|, ∀i∈{1, 2, . . . , n}, S represents the total number of the fixed-length containers after the service data flow is segmented, sᵢ represents the number of the fixed-length containers transmitted by each available subflow, and n is the number of subflows available for data forwarding from the transmitter to the receiver in the network; if an individual does not accord with the constraint condition, the constraint violation value is the absolute value of the true constraint function value; if the individual accords with the constraint condition, the constraint violation value is 0; normalizing the constraint violation value to give a constraint violation degree, wherein the value range of the constraint violation degree is [0,1]; in a multi-objective optimization evolution algorithm, classifying feasible solutions and infeasible solutions using the constraint violation degree as a criterion, wherein individuals with a constraint violation degree of 0 correspond to the feasible solution, and individuals without a constraint violation degree of 0 correspond to the infeasible solution.

Further, the process of the transmitter segmenting the service data flow requesting communication forwarding includes:
the transmitting terminal node SRC first delivering to the central controller service request information that shall comprise a data flow F waiting for communication forwarding, F being defined as a quaternion F≡ [symbol] SRC, DST, B, D [symbol] , wherein SRC and DST respectively represent the transmitting terminal node and the receiving terminal node of the data flow F, B∈N* represents the length of the data flow, and D∈R⁺ is an acceptable maximum communication forwarding time of the data flow; and
the transmitting terminal node SRC segmenting raw data of the data flow F before distribution, placing the data packet sequentially into a plurality of fixed-length containers with the same length as per the positional sequence in an original data flow for later use; switching to the next fixed-length container for placing the data packet when a current fixed-length container is full or the remaining space is insufficient for placing a complete data packet; sequentially allocating consecutive sequence numbers as a unique identifier to the fixed-length container; and setting in advance the length of the fixed-length container to L, satisfying a condition L∈N*.

Further, the specific implementation of distributing in rounds the segmented fixed-length containers to the corresponding subflows to prepare for the parallel transmission includes:
arranging as many as possible the fixed-length containers to perform multi-subflow parallel transmission according to a flow segmentation ratio in the configuration information by using the buffer C_{buffer} at the receiving terminal as the reference indicator of the total number of the fixed-length containers in each round of transmission, on the premise that the buffer can accommodate the fixed-length containers, and computing the total number of the transmitted data packets in each round using the following formula C_{rounds}; wherein

$$m ( 1 + ⌈ \frac{{s}_{2}}{{s}_{1}} ⌉ + … + ⌈ \frac{{s}_{n}}{{s}_{1}} ⌉ ) \leq {C}_{buffer} \leq ( m + 1 ) ( 1 + ⌈ \frac{{s}_{2}}{{s}_{1}} ⌉ + … + ⌈ \frac{{s}_{n}}{{s}_{1}} ⌉ )$$

$$⌈ \frac{{C}_{buffer}}{1 + ⌈ \frac{{s}_{2}}{{s}_{1}} ⌉ + … + ⌈ \frac{{s}_{n}}{{s}_{1}} ⌉} - 1 ⌉ \leq m \leq ⌊ \frac{{C}_{buffer}}{1 + ⌈ \frac{{s}_{2}}{{s}_{1}} ⌉ + … + ⌈ \frac{{s}_{n}}{{s}_{1}} ⌉} ⌋$$

$${C}_{rounds} = m ( 1 + ⌈ \frac{{s}_{2}}{{s}_{1}} ⌉ + … + ⌈ \frac{{s}_{n}}{{s}_{1}} ⌉ )$$

sᵢ, i∈{1, 2, . . . , n} represents the number of the segmented fixed-length containers transmitted by each available subflow, n is the number of subflows available for forwarding data from the transmitter to the receiver in the network, and m is a positive integer variable;
the transmitting terminal node determining an optimal load situation of each subflow in each round based on the configuration information issued by the central controller and C_{rounds}, distributing in rounds the segmented fixed-length containers to the corresponding subflows, and preparing for the subsequently mapping to the physical network for the multi-subflow parallel transmission.

Compared with existing scheduling solutions, the present disclosure has the following advantages:

(1) The present disclosure makes full use of the rich parallel paths in the new intelligent computing center network. These paths, after balancing, can provide a more efficient transmission service for elephant flows and meet the communication demands of the distributed large AI model training service. Multi-path parallel transmission can make full use of available bandwidth in the network and effectively shorten the delay of forwarding data on a physical link. Although an additional delay of the sorting and reassembly operation at the receiving terminal will be introduced, an optimal solution can be found by controlling a flow segmentation situation and balancing the increase and the decrease of the delay, which really gives play to the advantages of parallel transmission and greatly shortens the total communication forwarding delay of elephant flows. In addition, the multi-path mode can avoid network resource fragmentation caused by single-flow single-path strategies, alleviate the problem that the elephant flows may wait in a queue at the transmitting terminal due to the absence of sufficient complete residual bandwidth, and effectively improve the utilization rate of network bandwidth resources.

(2) The present disclosure proposes to achieve elephant flow transmission by using subflows as the scheduling granularity. The scheduling based on subflows resolves the problems of excessive granularity and insufficient flexibility, uneven network loads, prolonged communication time, and the fragmentation and waste of network resources in conventional scheduling methods based on flows. Compared with existing scheduling modes based on data packets, the scheduling solution based on subflows has a higher granularity, which alleviates the problem that the data packets in parallel transmission are severely out of sequence, leading to difficulties in processing and long reassembly time. The scheduling of elephant flows based on subflows achieves the balance between the parallel transmission delay of the elephant flow on the link and the sorting and reassembly delay at the receiving terminal, and can effectively shorten the communication completion time of elephant flows.

(3) The present disclosure introduces the idea of fusing a plurality of modalities of a future network. Considering the possible differences in the network modalities and the great differences in the performance such as delays of different subflows, an independent analysis and computation are performed on the delay of each subflow. The method is widely applicable to a plurality of network architectures that may exist in intelligent computing centers at present and in the future.

### BRIEF DESCRIPTION OF THE DRAWINGS

FIG. 1 is a schematic flowchart of a parallel forwarding and scheduling processing of a control plane according to an embodiment of the present disclosure.

FIG. 2 is a schematic flowchart of a parallel forwarding and sorting processing of a data forwarding plane according to an embodiment of the present disclosure.

FIG. 3 is a schematic diagram of the cooperation relationship between the segmentation and distribution and the sorting and reassembly strategies according to an embodiment of the present disclosure.

FIG. 4 is a schematic flowchart of a multi-objective evolution optimization algorithm of a central controller according to an embodiment of the present disclosure.

### DESCRIPTION OF THE EMBODIMENTS

In view of the new demand features of elephant flow communication in an intelligent computing service, the scheduling mechanism needs to comprehensively consider the cooperation of data flow segmentation and distribution operation at the transmitting terminal and data packet sorting and reassembly operation at the receiving terminal, so as to find an optimal flow segmentation ratio of the elephant flow and map the optimal flow segmentation ratio to a physical network and complete the multi-subflow parallel transmission based on an optimal forwarding path, thereby achieving two core objectives: minimizing the communication completion time of the elephant flow and maximizing the network resource utilization rate. In this way, the advantage of multi-path parallel forwarding is really exerted, and the delay of data through network communication forwarding during a distributed large AI model training is effectively reduced, thereby improving the intelligent computing resource utilization rate, and providing crucial network communication service assurance for the continuous development of large AI models.

The present disclosure takes a new intelligent computing center network as the application scene, and by optimizing the scheduling and forwarding of the service data flow of a distributed large AI model training, proposes an efficient scheduling mechanism of multi-subflow parallel forwarding, which divides the entire communication forwarding process into three stages: data flow segmentation and distribution, parallel transmission, and receiving terminal sorting and reassembly. By taking the cooperation of the data flow segmentation and distribution strategy at the transmitting terminal and the sorting and reassembly operation of out-of-sequence data packets at the receiving terminal into consideration, the optimal elephant flow segmentation ratio is determined and mapped to a physical network to complete the multi-subflow parallel transmission.

The method for multi-subflow parallel forwarding and scheduling according to the present disclosure solves the problem of the failure of conventional network scheduling methods caused by the new features of distributed large AI model training service data flows in new intelligent computing centers such as limited number of flows and large bandwidth of a single flow. The present disclosure makes full use of the network resources, balances the network loads, effectively shortens the network transmission delay, and alleviates the dilemma that the network currently becomes the bottleneck of the large AI model training. For a better understanding, the present disclosure will be further illustrated below with reference to the drawings and examples.

### Example I

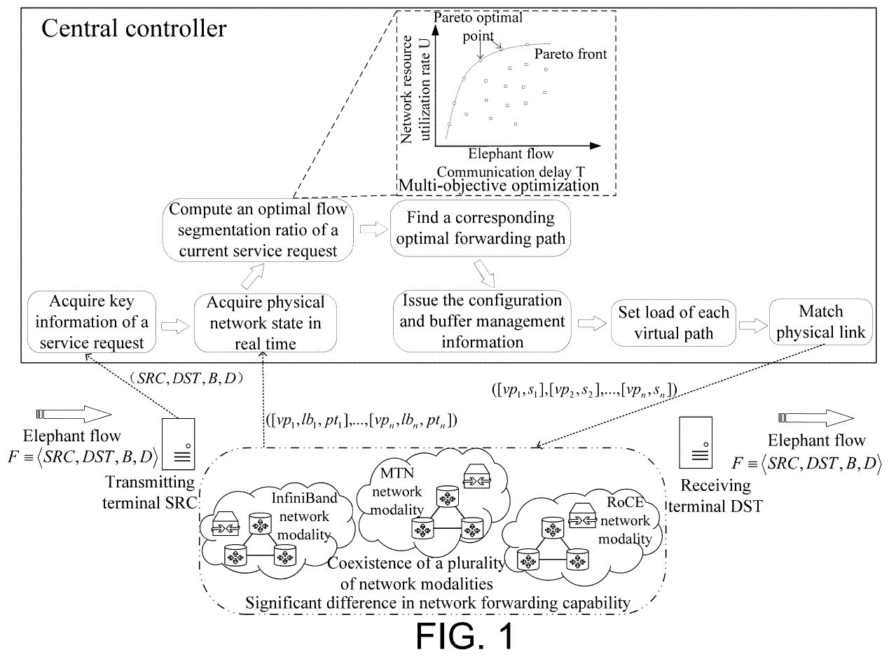

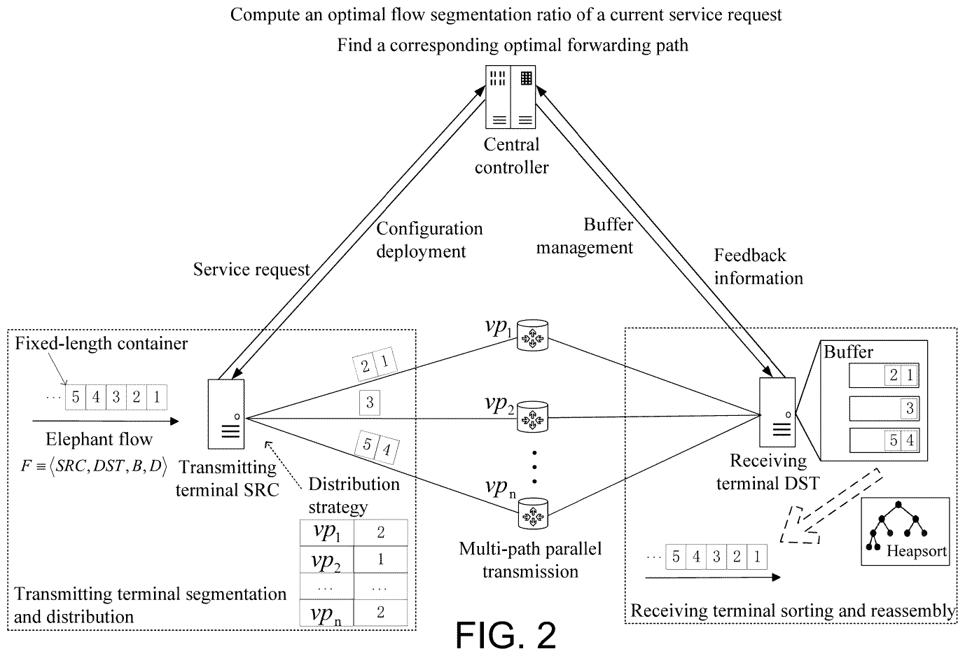

Referring to FIGS. 1 and 2, the example of the present disclosure provides the overall architecture of a multi-subflow parallel forwarding and scheduling mechanism in a new intelligent computing center network, which can effectively reduce the communication forwarding delay of an elephant flow, improve the network resource utilization rate, and better meet the communication demand of the service data flow of a distributed large AI model training. This, to a certain extent, compensates for the discrepancy between the current new intelligent computing center network and the service demand, improves the efficiency and effects of training large models, and helps the continuous development of the AI industry. In addition, this solution has the capability of adapting to the fusion of a plurality of modalities of future networks.

To improve the effective bandwidth of the new intelligent computing center network, the principle of the example of the present disclosure is to achieve an efficient multi-subflow parallel transmission. Therefore, the entire elephant flow communication forwarding process is divided into three stages: a data flow segmentation and distribution stage, a parallel transmission stage, and a receiving terminal sorting and reassembly stage. The specific procedures of each stage are as follows.

In the data flow segmentation and distribution stage, the transmitting terminal node SRC is the most important working object. SRC first needs to deliver service request information to a central controller. The information needs to include a data flow F waiting for communication forwarding, and F is defined as a quaternion F≡ [symbol] SRC, DST, B, D [symbol] . SRC and DST respectively represent the transmitting terminal node and the receiving terminal node of the data flow F, B∈N* represents the length of the data flow, and D∈R⁺ is the acceptable maximum communication forwarding time of the data flow. The transmitting terminal node SRC needs to segment the raw data of the data flow F before distribution. The data packets are sequentially placed into a plurality of fixed-length containers with the same length as per the positional sequence in an original data flow for later use. In this process, the procedure is switched to the next fixed-length container for placing the data packet when a current fixed-length container is full or the remaining space is insufficient for placing a complete data packet. Consecutive sequence numbers are sequentially allocated to the fixed-length containers as a unique identifier. This identifier is used by the receiving terminal to confirm the order and the integrity, so as to correctly reassemble the containers into the original data flow F. It is known that the data flow of the large model training communication service in the intelligent computing center is characterized by a small number of flows and a large bandwidth of a single flow. That is, the data volume of F will be very large. Therefore, selecting a fixed-length container for segmentation does not cause a remarkable space waste. In addition, compared with a variable-length segmentation solution, a fixed-length container is more convenient to sort and reassemble at the receiving terminal, which can reduce unnecessary overheads and thereby shorten the overall communication forwarding time. In addition, the fixed-length container can effectively avoid the polarization problem caused by the variable length of segmentation that some extremely large data blocks and some other extremely small data blocks may be present after the segmentation, thereby helping balance the network loads. The length of the fixed-length container is set in advance to L, satisfying the condition L∈N*. The transmitting terminal node determines the optimal load situation corresponding to each subflow in each round based on the configuration information issued by the central controller, and distributes in rounds the segmented fixed-length containers to the corresponding subflows for parallel transmission.

In the parallel transmission stage, to facilitate analyzing the delay of the parallel transmission of the data flow F on a plurality of available independent subflows vpᵢ, complex network topologies such as CLOS, FatTree, and Dragonfly may be modeled as a directed graph G≡(V,E), where V={v₁, v₂, . . . , v_{λ}} represents a set of λ terminal nodes in the network, and E={e_{xy}|x, y∈{1, 2, . . . , λ}, x≠y} represents a set of available subflows among all the nodes in the network. In the above expressions,

$${e}_{xy} = \{ {vp}_{xy}^{i} \vert x , y ∈ \{ 1 , 2 , … , λ \} , x \neq y , i ∈ \{ 1 , 2 , … , n \} \}$$

is defined as a set of n available subflows from the transmitting terminal node vₓ to the receiving terminal node v_{y}. Considering that it is extremely possible for future intelligent computing centers to have an application scene in which a plurality of network modalities coexist, the network modalities of a plurality of different subflows used for communication of one data flow may be different. The plurality of different subflows may have a large difference in performance such as delays. This is directly represented as follows: when data of the same length are transmitted and different subflows vpᵢ are selected, the delays tᵢ of the parallel transmission may vary greatly. Therefore, it is very necessary to separately analyze and compute the delay of each subflow. tᵢ, tᵢ∈R⁺ consists of two parts: a transmitting delay stᵢ and a propagation delay ptᵢ. The formula is:

$${t}_{i} = {st}_{i} + {pt}_{i} .$$

The transmitting delay is the time needed for data transmission inside a network device. That is, the time starting from the first bit of transmitting the data to the last transmitted bit. The transmitting delay is determined by the data length and the transmitting rate. The propagation delay is the time needed for data propagation for a certain distance on a physical link in the form of an electromagnetic wave. The propagation delay is closely related to the physical length of the channel and the propagation speed of the signal on the physical medium, and is unrelated to the size of the data. For a specific network, it can be considered that the propagation delay corresponding to the subflow vpᵢ fluctuates within a certain range, and is represented by a symbol ptᵢ.

In the receiving terminal sorting and reassembly stage, the main work is that the receiving terminal node DST sorts out-of-sequence fixed-length containers based on sequence numbers and completes the reassembly, and then submits feedback to the central controller to complete the communication forwarding. Although the transmitting terminal node sequentially distributes the fixed-length containers in the sequence of the sequence numbers, as multiple subflows are used for parallel transmission, the network modalities of the paths corresponding to each subflow may be different, the delay features may be different, and the real-time congestion situations of the paths may also be different. Consequently, the sequence in which the fixed-length containers actually arrive at the receiving terminal may be disordered. Out-of-sequence fixed-length containers are buffered by the receiving terminal, wait until the arrival of the last fixed-length container in the same round is confirmed, and are jointly subjected to the sorting and reassembly operation. The buffer mechanism at the receiving terminal node has a great impact on the operation in the flow reassembly stage. Considering the periodic feature of the distributed large model training service, the data flows that need to be forwarded in a service request often burst synchronously, and the receiving terminal node in the intelligent computing center network often faces an all-to-one communication situation. To clearly distinguish the segmented fixed-length containers from different data flows forwarded by different transmitting terminal nodes, the receiving terminal allocates an independent space for the corresponding data flow for classification and buffering after receiving the buffer management information issued by the central controller. The detailed buffering operation is as follows: If the data packet is the first data packet arriving at the receiving terminal on the subflow, the receiving terminal creates a new buffer queue in the corresponding independent space for the data packet for temporary storage. Otherwise, the data packet is directly placed into a corresponding buffer queue for temporary storage.

The specific procedures in the example of the present disclosure is described in detail with reference to FIGS. 1 and 2.

In step 1, a transmitter, after receiving the elephant flow forwarding service request, uploads key information in the request to the central controller, for example, the transmitting terminal node SRC, the receiving terminal node DST, the elephant flow length B, and the maximum communication delay D.

In step 2, the central controller acquires a physical network state in real time, and determines the number of subflows available for data forwarding from the transmitter SRC to the receiver DST in the network and information such as the currently remaining physical bandwidth and the propagation delay of the link corresponding to each subflow path.

In step 3, the physical network state information acquired in step 2 is used as an input, and the central controller takes a minimized total delay of data flow communication forwarding and a maximized network resource utilization rate as the objectives, computes the optimal flow segmentation ratio of the current service request, and configures the number of the fixed-length containers loaded on the corresponding virtual path.

In step 4, the transmitter segments the original elephant flow, assembles the data packets into fixed-length containers of the preset length on the premise that the integrity of the data packets is ensured, and allocates consecutive sequence numbers as a unique identifier to the fixed-length containers sequentially. In the subsequent elephant flow forwarding process, the fixed-length container is used as the minimum unit for transmission in the network.

In step 5, the transmitting terminal node maps the deployment of the physical network based on the configuration information issued in step 3, and performs parallel transmission in rounds with subflows as the granularity. The fixed-length containers are distributed as many as possible to perform multi-subflow parallel transmission according to a flow segmentation ratio in the configuration information in each round by using the buffer at the receiving terminal as the reference indicator of the total number of the fixed-length containers in each round of transmission, on the premise that the buffer can accommodate the fixed-length containers.

In step 6, the central controller issues the buffer management information to the corresponding receiving terminal. The receiving terminal allocates an independent space for the data flow for classifying and buffering the out-of-sequence fixed-length containers after receiving the buffer management information.

In step 7, the receiver submits, after each round of parallel transmission ends, out-of-sequence fixed-length containers in the buffer to an upper layer after performing the sorting and reassembly operation. The receiver needs to feed information back to the central controller. After receiving the information, the central controller notifies the transmitter to start the next round of parallel transmission until the forwarding of the entire service data flow is completed.

The specific procedures of step 2 will be illustrated in detail below. In the example of the present disclosure, F is used to represent the elephant flow that requests communication forwarding, and F may be defined as a quaternion F≡ [symbol] SRC, DST, B, D [symbol] . SRC and DST respectively represent the transmitting terminal node and the receiving terminal node of the data flow. B∈N* represents the length of the data flow. D∈R⁺ is the acceptable maximum communication forwarding time of the data flow. Assuming that when receiving the communication forwarding request of F, the central controller acquires n subflows existing in the network available for the data forwarding from the transmitting terminal node SRC to the receiving terminal node DST vPᵢ, i∈{1, 2, . . . , n} is used for representing the ith available subflow. In the example of the present disclosure, assuming that these n subflows are independent from each other, the path used by the subflow vpᵢ corresponds to the link i. The currently available physical bandwidth of the link i is defined as lbᵢ, lb∈N*. The number of fixed-length containers of the actual loaded data flow F on the link i is sᵢ, sᵢ∈N. vpᵢ can be represented by a tuple vpᵢ= [symbol] lbᵢ, sᵢ, ptᵢ [symbol] . In a scene in which a plurality of network modalities coexist in the intelligent computing center, links of these subflows may be constructed by using different network modalities. These links may be different in performance indicators such as delays and bandwidths. Therefore, the propagation delays corresponding to the links from SRC to DST in the same way may have great differences. To better fit the actual situation of the intelligent computing center network, ptᵢ is used in the model to estimate the propagation delay of the link i. The value of the propagation delay is unrelated to the data allocated to the link i, and can be acquired from the feedback information at the receiving terminal.

In the conventional Ethernet, scheduling and forwarding are performed by using a flow as the minimum unit. A classic algorithm is the Equal-Cost-Multi-Path (ECMP) Routing Algorithm, which hashes the data flows with the same quintuple to the same path for transmission. It is known that the service data flow of the large AI model training in the new intelligent computing center is characterized by a small number of flows and a large bandwidth of a single flow. In this scene, scheduling based on the flow easily results in polarization. That is, some elephant flows are concentrated to the same path by hash selection. This is prone to cause a traffic overload on a small number of paths in the entire network while the use of link bandwidths on other paths is inefficient. The network loads are severely uneven. Another existing scheduling mode is to select a path for the data packets in the data flow one by one, and to perform balancing by using the granularity of packets. Different data packets on the same flow may select different paths for transmission. This scheduling mode based on the packet theoretically has the minimal granularity, and can make full use of the available residual bandwidth in the network for forwarding. However, this will cause the out-of-sequence problem when the data packet arrives at the receiving terminal. A severe out-of-sequence problem causes a significant decrease in the throughput, and requires a large amount of additional out-of-sequence reassembly work consuming buffer and CPU resources. The out-of-sequence problem is an important reason for poor performance of scheduling based on packet and difficulties in supporting large-scale network traffic forwarding.

To resolve the above problems and select a more proper granularity for scheduling and forwarding, a scheduling solution based on subflows is designed in the example of the present disclosure. Firstly, in step 4, the elephant flow is segmented. The specific operation is as follows: After receiving the service request, the transmitting terminal node SRC records the data packets into the fixed-length containers of the preset length to the maximum extent on the premise that the integrity of the data packets is ensured. When the data packets exceed the preset length of the fixed-length container, the data packets are recorded into the next fixed-length container. The transmitting terminal sequentially allocates consecutive sequence numbers to the fixed-length container as a unique identifier. This identifier is used by the receiving terminal to confirm the order and the integrity of the received fixed-length containers, so as to correctly reassemble them into the original data flow. In the parallel transmission process, the fixed-length container is used as the minimum operating unit to select a path, so as to ensure that all the data packets belonging to the same fixed-length container are scheduled to the same subflow path for forwarding, and that the data packets in the fixed-length containers are ordered upon arrival at the receiving terminal. Different paths may be selected for different fixed-length containers for transmission based on the configuration information issued by the central controller, so as to achieve multi-subflow parallelism and increase the network effective bandwidth. The out-of-sequence problem among different fixed-length containers that may be present at the receiving terminal due to the different transmission delays of different subflows can be solved by simply sorting and reassembling the fixed-length containers. Compared with dealing with the out-of-sequence problem of the data packets, this can reduce unnecessary overheads, shorten the overall communication forwarding time, and really give play to the advantages of multi-path parallelism.

If the fixed-length containers are out of sequence, the fixed-length containers need to be buffered at the receiving terminal and wait for sorting and reassembly. Once an excessively large number of fixed-length containers are buffered, it is likely that severe buffer congestion will occur, and global communication forwarding performance will be affected. Therefore, multi-subflow parallel transmission is performed in rounds, and an appropriate total number of the transmitted fixed-length containers is selected for each round, thereby ensuring that the receiving terminal can process in time the out-of-sequence fixed-length containers in the buffer after each round ends, and compensating for the additional computing costs and time costs that may be caused by an excessively large number of rounds. In step 5, the maximum number C_{buffer} of fixed-length data packets that can be accommodated in the buffer at the receiving terminal is used as the basic indicator, and the transmission completion time of the multi-subflows in each round is synchronized as much as possible. The total number C_{rounds} of the data packets transmitted in each round may be computed by using the following formula:

$$m ( 1 + ⌈ \frac{{s}_{2}}{{s}_{1}} ⌉ + … + ⌈ \frac{{s}_{n}}{{s}_{1}} ⌉ ) \leq {C}_{buffer} \leq ( m + 1 ) ( 1 + ⌈ \frac{{s}_{2}}{{s}_{1}} ⌉ + … + ⌈ \frac{{s}_{n}}{{s}_{1}} ⌉ )$$

$$⌈ \frac{{C}_{buffer}}{1 + ⌈ \frac{{s}_{2}}{{s}_{1}} ⌉ + … + ⌈ \frac{{s}_{n}}{{s}_{1}} ⌉} - 1 ⌉ \leq m \leq ⌊ \frac{{C}_{buffer}}{1 + ⌈ \frac{{s}_{2}}{{s}_{1}} ⌉ + … + ⌈ \frac{{s}_{n}}{{s}_{1}} ⌉} ⌋$$

$${C}_{rounds} = m ( 1 + ⌈ \frac{{s}_{2}}{{s}_{1}} ⌉ + … + ⌈ \frac{{s}_{n}}{{s}_{1}} ⌉ )$$

Step 6 is the operation of buffering the out-of-sequence fixed-length containers at the receiving terminal based on the subflow scheduling solution designed in the example of the present disclosure. The out-of-sequence fixed-length containers that arrive at the receiving terminal are buffered by the receiving terminal, wait until the arrival of the last fixed-length container in the same round is confirmed, and are jointly subjected to the sorting and reassembly operation. The buffer mechanism at the receiving terminal has a great impact on the operation in the flow reassembly stage. Considering the periodic feature of the distributed large model training service, the data flows that need to be forwarded in a service request often burst synchronously, and the receiving terminal node in the intelligent computing center network often faces an all-to-one communication situation. To clearly distinguish different data flows forwarded by different transmitting terminal nodes, the receiving terminal allocates an independent space for each data flow for classification and buffering based on the buffer management information issued by the central controller. The detailed buffering operation is as follows: If a certain fixed-length container is the first fixed-length container arriving at the receiving terminal on the subflow and requiring buffering, the receiving terminal creates a new buffer queue for the fixed-length container in the corresponding independent space for temporary storage; otherwise, the fixed-length container is directly placed in a corresponding buffer queue for temporary storage. After each round of parallel transmission ends, the receiver submits out-of-sequence fixed-length containers in the buffer to an upper layer after performing the sorting and reassembly operation, and feeds information back to the central controller, and finally clears the corresponding buffer space to wait for the fixed-length containers in the next round of multi-subflow parallel transmission.

### Example II

Referring to FIG. 2, the example of the present disclosure provides a method in which the strategy of a transmitting terminal performing segmentation and distribution and the strategy of a receiving terminal performing resorting and reassembly cooperate with each other in a multi-subflow parallel forwarding and scheduling mechanism. The multi-subflow parallel forwarding and scheduling mechanism designed in the present disclosure provides an efficient service for a new intelligent computing center network in the background of a distributed large AI model training. The reduction of the delay of data communication forwarding between parallel computing devices through a network is crucial to the distributed large model training. The communication delay not only relates to the efficiency and costs of the large model training, but also affects the synchronous updating of model parameters between nodes. The update lag of some nodes causes a decrease in the convergence rate and the final quality of the large model. Therefore, how to perform optimal subflow distribution and allocate a proper fixed-length container load to each subflow to minimize the communication forwarding delay of an elephant flow is the key optimization objective in the multi-subflow parallel forwarding and scheduling mechanism.

In the example of the present disclosure, a multi-subflow parallel forwarding and scheduling mechanism is designed to optimize the communication forwarding performance of the network facing an ultra-large bandwidth service data flow. The total communication delay T of the data flow F consists of three parts: a segmentation and distribution delay t_{d}, a parallel transmission delay t, and a sorting and reassembly delay t_{c}. The formula is described as T=t_{d}+t+t_{c}. The segmentation and distribution delay t_{d} is slightly affected by different flow segmentation operations, and the impact on T can be basically omitted. Therefore, the parallel transmission delay t and the sorting and reassembly delay t_{c} are decisive factors for optimizing T in the multi-subflow parallel forwarding and scheduling mechanism. As multi-subflow and multi-path strategies can make full use of available bandwidth in the network, balance the network load, and improve the network resource utilization rate, the effective bandwidth of the network is significantly improved, and the transmission delay t of the data flow is also reduced accordingly. In addition, by analyzing the computing formula of t, it can be roughly learned that the data flow transmission delay t can be further shortened by properly transmitting the same data flow in parallel by using more subflows. The sorting and reassembly delay t_{c} is the time spent by the receiving terminal on reassembling a correct and complete original data flow after sorting received data packets that may be out of sequence. It can be known from a qualitative analysis that a greater number of subflows actually used by the data flow during the parallel transmission may lead to a more severe out-of-sequence problem when the subflows arrive at the receiving terminal. The receiving terminal definitely needs to take a longer period to perform more complex sorting and reassembly to give the original data flow. That is, the value of t_{c} is also greater. Briefly, t_{c} is a variable positively correlated to the total number of the divided subflows. In practical applications, in addition to the number of subflows, the delay t_{c} in the sorting and reassembly stage may also be affected by other factors. However, this model is established mainly for discussing an optimal scheduling strategy for multi-subflow parallel transmission of an ultra-large bandwidth data flow. It may be assumed that other secondary impact factors are completely the same to simplify the model.

In conclusion, for different subflow division solutions of the same data flow, the parallel transmission delay t and the sorting and reassembly delay t_{c} are two factors that affect and restrict each other, and jointly determine the change of the total communication delay T of the service data flow F requested to be forwarded (to minimize the total communication forwarding delay of the data flow). In the example of the present disclosure, an optimization algorithm in the central controller is designed. By trying different subflow division solutions, the optimal balance between the parallel transmission delay t and the sorting and reassembly delay t_{c} is found. The cooperation between the segmentation and distribution strategy at the transmitting terminal and the sorting and reassembly strategy at the receiving terminal is explored. Consequently, the key decision objective that the total communication forwarding delay T of the service data flow is minimized and the network resource utilization rate U of the service data flow is maximized is achieved. It should be noted that the optimization algorithm of the central controller designed in the example of the present disclosure allows the special situation in which the decision result degrades into single-path scheduling. That is, for a specific service request and an actual network state, when only one subflow path in the configuration information is loaded in the optimization result output in correspondence with the completion time of the algorithm minimization task, the network will directly select a path based on the configuration information and will complete the communication forwarding of the service data flow in a single-flow and single-path mode.

### Example III

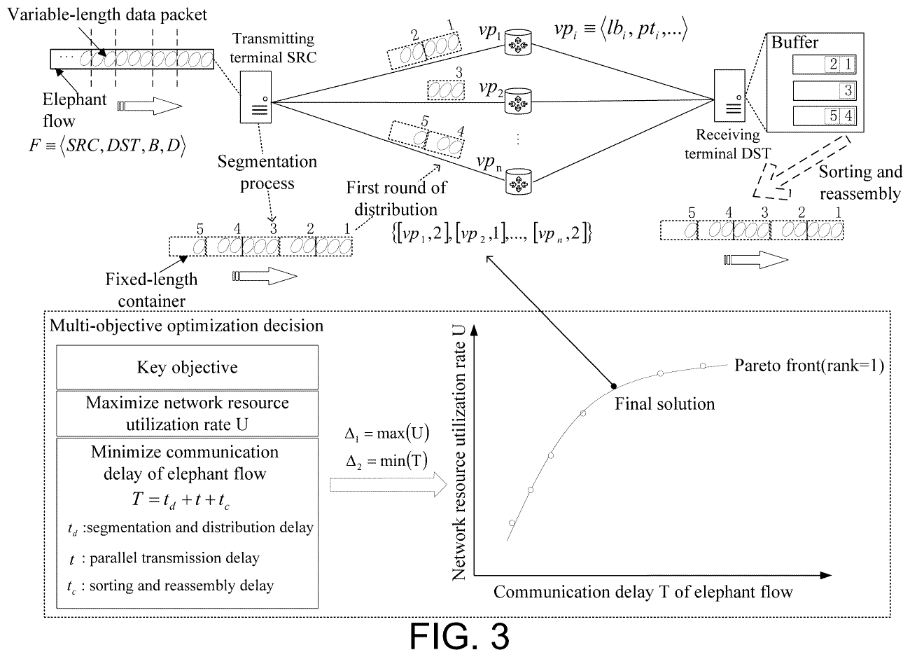

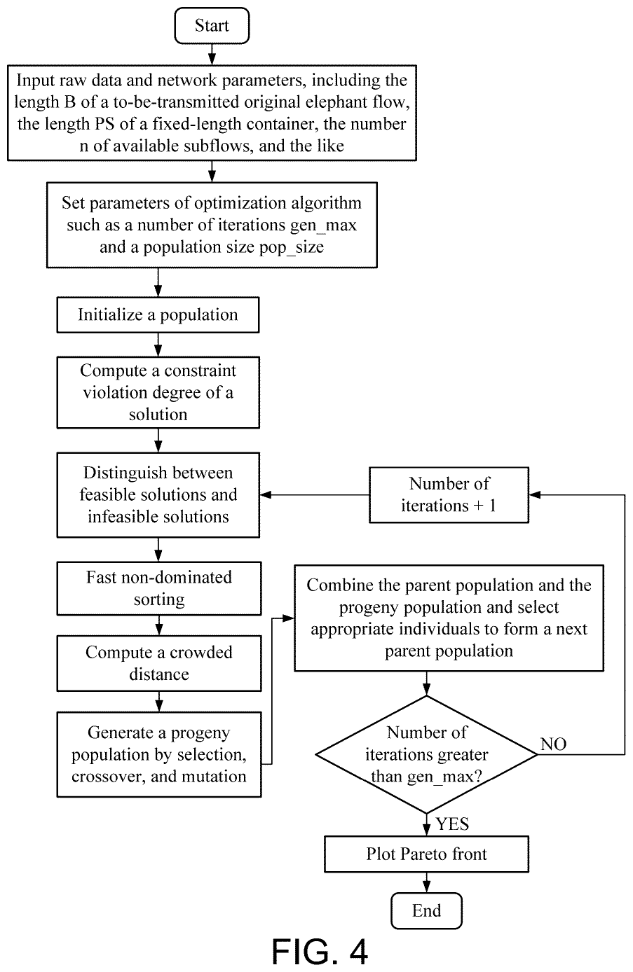

Referring to FIGS. 3 and 4, the example of the present disclosure provides a multi-objective optimization method for determining an optimal flow segmentation ratio by a central controller in a multi-subflow parallel forwarding and scheduling mechanism. The constrained NSGA-II algorithm can determine the optimal number of divided subflows based on the information acquired in real time in a physical network, such as the number of available subflows that can be used for data forwarding from a transmitter to a receiver, a currently available physical bandwidth, and the propagation delay of a link corresponding to each subflow path, and allocate a proper load to each subflow, thereby effectively shortening the communication forwarding delay of an elephant flow and improving the network resource utilization rate in an intelligent computing center. The constraint condition restricts that the total number of fixed-length containers transmitted by all the subflows shall be consistent with the number of fixed-length containers segmented from the original elephant flow. This may ensure that the receiving terminal receives complete and non-repeated data. The constrained NSGA-II algorithm specifically includes the following steps:

In step 1, preset data and acquired network parameters are input, including the length PS of a fixed-length container, the length B of a to-be-transmitted original elephant flow, the number n of available subflows, and the like.

In step 2, parameter settings of an optimization algorithm are adjusted, including the number of iterations, the population size, the distribution index of crossover and mutation operation, and the like.

In step 3, a population is initialized, that is, an initial population with a size of M is randomly generated.

In step 4, the constraint violation degree of a solution is computed, and feasible solutions and infeasible solutions are distinguished based on a rule.

In step 5, fast non-dominated sorting is performed, following an advantageous/disadvantageous solution comparison principle of the method for distinguishing feasible solutions and infeasible solutions under a constraint condition.

In step 6, the crowded distance of each individual in a non-dominated layer is computed based on the sorting results, and appropriate individuals based on a crowded-comparison operator are selected to form a new parent population.

In step 7, selection, crossover, and mutation operations are performed on the parent population by using a genetic algorithm to give a progeny population.

In step 8, the parent population and the progeny population are combined to form a new population with a scale of 2M, and appropriate individuals are selected to form the next parent population.

By analogy, steps 4 to 8 are repeated until the number of iterations reaches the preset maximum value, and the loop is stopped. The corresponding Pareto front at this time is plotted, and the arithmetic program ends.

How to initialize the population in step 3 will be illustrated in detail below. Each individual in the population is a row vector consisting of n elements, which can be represented as {s₁, s₂, . . . , sₙ}. n is the number of the subflows available for data forwarding from the transmitter to the receiver in the network. Each element sᵢ, i∈{1, 2, . . . , n} is a nonnegative integer, and corresponds to the number of segmented fixed-length containers that need to be transmitted and are allocated to each available subflow. sᵢ=0 indicates that no data flow transmission task is allocated to the available subflow. To ensure that the receiving terminal receives complete and non-repeated data, it needs to be ensured that the constraint condition is met when the initial population is randomly generated. Therefore, the total number Σₛ_{ᵢ}_{≠0}sᵢ, ∀i∈{1, 2, . . . , n} of the fixed-length containers transmitted by all the available subflows needs to be consistent with the number S of the fixed-length containers segmented from the original data flow. In conclusion, the initial population operation may be specifically described as follows: randomly generating M row vectors consisting of n integers with the sum being a fixed value S.

In the optimization problem, the constraint condition can be processed in a plurality of ways, among which a penalty function method and a method of distinguishing between feasible solutions and infeasible solutions are commonly used. The penalty function method needs to construct a penalty function based on the features of the constraint, add the penalty function to an objective function to convert a constrained problem into an unconstrained problem, and then solve the problem by a conventional method. However, the penalty function method has the inherent defect that it is difficult to set a penalty factor. The method for distinguishing between feasible solutions and infeasible solutions is a processing skill based on the comparison principle. Feasible solutions and infeasible solutions are distinguished based on whether the solution accords with the constraint condition. A solution that accords with the constraint condition is a feasible solution, and a solution that does not accord with the constraint condition is defined as an infeasible solution. The method for distinguishing between feasible solutions and infeasible solutions can process most of the constrained optimization problems on the basis of a relatively small change to the unconstrained optimization algorithm, such that the optimal solution search can approach the feasible region, and then quickly approach the Pareto front.

Based on this, the present disclosure defines the violation value err of each individual in step 4. err is computed as err=abs(c), where C is the row vector and satisfies c(1)=|S−Σₛ_{ᵢ}_{≠0}sᵢ|, ∀i∈{1, 2, . . . , n}. It can be concluded from the computing principle that if an individual does not accord with the constrained condition, the constraint violation value is the absolute value of the true constraint function value; if the individual accords with the constraint condition, the constraint violation value is 0. The constraint violation value is normalized to give a constraint violation degree, and the range of the constraint violation degree is [0,1]. Feasible solutions and infeasible solutions are distinguished using the constraint violation degree as the criterion. An individual with a constraint violation degree of 0 corresponds to a feasible solution, and an individual without a constraint violation degree of 0 corresponds to an infeasible solution.

In step 5, in the constrained NSGA-II multi-objective optimization for distinguishing between feasible solutions and infeasible solutions, the corresponding improvement in the advantageous/disadvantageous solution comparison principle of the fast non-dominated sorting is as follows: (1) In any situation, a feasible solution is unconditionally superior to an infeasible solution. (2) The comparison between feasible solutions is still performed based on the rules of the original unconstrained optimization algorithm. (3) The comparison between infeasible solutions gives priority to the solution with a smaller constraint violation degree. Specific operations of the fast non-dominated sorting are as follows: Two parameters bₖ and dₖ are allocated to each solution, where bₖ represents the number of solutions that dominate the kth solution, and dₖ represents the number of solutions that dominate the kth solution. The values of bₖ and dₖ of each solution are firstly computed in a traversal manner. It can be known that a solution satisfying bₖ=0 is located on the first non-dominated layer. All the solutions on the first non-dominated layer may be represented by the set U₁. For a solution in the set U₁, bₖ of the dominated solution is subtracted by 1. At this time, the new solution of bₖ=0 is an individual on the second non-dominated layer. These new solutions of bₖ=0 are placed into the set U₂. By repeating the above steps, all the non-dominated layer sets can be sequentially found in the rank order, and each set is given a non-dominated rank.

In step 6, the crowded distance is defined first. For each objective function, two solutions adjacent to the function value corresponding to the current solution are found, and the function difference between the two solutions is computed. The result of summing all the computed differences is the crowded distance of the current solution. In particular, for individuals located on the boundary, the crowded distance cannot be computed based on the above definition due to the lack of adjacent solutions, and is set to infinity by default. It can be learned from analyzing the above definition that a smaller crowded distance represents a more crowded surrounding of the solution. To ensure the uniformity of concentrated solutions distribution of approximate Pareto solutions, a crowded-comparison operator is designed based on two attributes, which are the non-dominated rank and the crowded distance of each individual in the population. This is expressed in terms of a partial order relation as:

$$I ≺ J ⇔ {I}_{rank} < {J}_{rank} or {I}_{rank} = {J}_{rank} ⋀ {I}_{distance} > {J}_{distance .}$$

That is, a solution with a lower rank value is preferentially selected. If two solutions have the same rank value, the solution with a greater distance value is preferentially selected over the solution with a smaller distance value.

The multi-subflow parallel forwarding and scheduling mechanism according to the present disclosure services a new intelligent computing center network in the background of a distributed large AI model training. The reduction of the delay of data communication forwarding between parallel computing devices through a network is crucial to the distributed large model training. The central controller according to this example determines a method for optimizing an optimal flow segmentation ratio, taking a minimized network forwarding delay of the service data flow trained by the large AI model and a maximized network resource utilization rate in the intelligent computing center as the two optimization objectives. The constrained NSGA-II multi-objective evolutionary optimization algorithm is used to determine the optimal number of segmented subflows and to allocate a proper load to each subflow. This is a key step for ensuring the efficient operation of the multi-subflow parallel forwarding and scheduling mechanism and for enabling the new intelligent computing center network to meet the demand of the distributed large model training service.

The optimal flow segmentation ratio of the elephant flow for the service request is determined based on the results of central controller optimization. The distribution plan of the transmitting terminal designed on this basis is mapped to the physical network to complete the multi-subflow parallel transmission. For a service request, the total communication delay T of the elephant flow in the multi-subflow parallel scheduling mechanism according to the present disclosure consists of three parts: a segmentation and distribution delay t_{d}, a parallel transmission delay t, and a sorting and reassembly delay t_{c}. Multi-subflow parallel mode can make full use of available bandwidth in the network, and effectively shorten the delay of forwarding data on a physical link. Although an additional delay of the sorting and reassembly operation at the receiving terminal will be introduced, the multi-objective optimization algorithm of the central controller can find an optimal solution by controlling the flow segmentation situation and keeping a balance between the increase and the decrease of the delays, thereby minimizing the completion time of the elephant flow. In addition, the multi-subflow mode can avoid network resource fragmentation caused by the single-flow strategies, alleviate the problem that the elephant flow may wait in a queue at the transmitting terminal due to the absence of sufficient complete available residual bandwidth, and effectively improve the utilization rate of network resources.

The above descriptions are only specific examples of the present disclosure with illustrative purposes, and are intended to illustrate the technical solutions of the present disclosure. The scope of the present disclosure is not limited thereto. Those skilled in the art can make appropriate modifications or changes thereto within the technical scope disclosed in the present disclosure. Such modifications or changes shall fall within the scope of the present disclosure without departing from the principle and the claims of the present disclosure.

What is claimed is:

1. A method for multi-subflow parallel forwarding and scheduling in a new intelligent computing center network that performs multi-subflow parallel forwarding and scheduling on a distributed large artificial intelligence (AI) model training service data flow in a new intelligent computing center, comprising:
in a data flow segmentation and distribution stage, segmenting a service data flow, placing data packets sequentially into fixed-length containers of a preset length for later use, and allocating consecutive sequence numbers as a unique identifier to the fixed-length containers sequentially; a transmitting terminal distributing segmented fixed-length containers to corresponding subflows in rounds based on configuration information issued by a central controller;
in a parallel transmission stage, completing a mapping of the configuration information to a physical network, selecting a path using one of the fixed-length containers as a minimum operating unit, and selecting different subflow paths for different fixed-length containers for forwarding, so as to achieve parallel transmission using subflows as the granularity; and
in a receiving terminal sorting and reassembly stage, a receiver submitting, after each round of the parallel transmission ends, out-of-sequence fixed-length containers in a buffer to an upper layer after sorting and reassembly; feeding information back to the central controller; and finally clearing a corresponding buffer space to wait for a next round of multi-subflow parallel transmission.

2. The method according to claim 1, wherein before a communication forwarding of a current service data flow, the central controller integrates and issues the configuration information and buffer management information, specifically comprising:
a transmitter, after receiving a service request, uploading key information contained in a request to the central controller;
the central controller acquiring a physical network state in real time, and determining a number of subflows available for data forwarding from the transmitter to the receiver in a network and a link performance indicator corresponding to each of the subflow paths, comprising a currently available physical bandwidth and a propagation delay; and
finding an optimal flow segmentation ratio of the current service data flow and a corresponding optimal forwarding path by using a acquired physical network state information as an input and taking a minimized total delay of data flow communication forwarding and a maximized network resource utilization rate as optimization objectives, so as to achieve an optimal balance between a parallel transmission delay and a sorting and reassembly delay, and integrating the configuration information and the buffer management information for issue by the central controller to a data forwarding plane to control parallel forwarding and scheduling.

3. The method according to claim 1, wherein the data flow segmentation and distribution stage comprises:
a transmitter segmenting the service data flow requesting communication forwarding; a transmitting terminal node recording the data packets into the fixed-length containers of the preset length to a maximum extent on a premise that an integrity of the data packets is ensured, and allocating the consecutive sequence numbers as the unique identifier to the fixed-length containers sequentially; and
the transmitting terminal node determining an optimal load situation corresponding to each subflow based on the configuration information issued by the central controller after completing a segmentation operation, synchronizing a transmission completion time of multi-subflow in each round as much as possible by using a maximum number of fixed-length containers that is accommodated in the buffer at the receiving terminal as a basic indicator, computing a total number of fixed-length containers transmitted in each round, and distributing in rounds the segmented fixed-length containers to the corresponding subflows to prepare for the parallel transmission.

4. The method according to claim 1, wherein the parallel transmission stage comprises:
scheduling all the data packets belonging to a same fixed-length container to a same subflow path for forwarding by using one of the segmented fixed-length containers as a minimum operating unit to select a path, and ensuring that the data packets in the fixed-length containers are ordered upon arrival at the receiving terminal; mapping different fixed-length containers to the physical network based on the configuration information issued by the central controller, selecting different paths for transmission, so as to achieve the multi-subflow parallel transmission.

5. The method according to claim 1, wherein the receiving terminal sorting and reassembly stage comprises:
the receiving terminal, after receiving buffer management information issued by the central controller, allocating an independent space for a current service data flow for buffering and classifying out-of-sequence fixed-length containers; the receiving terminal buffering the out-of-sequence fixed-length containers arriving at the receiving terminal, and creating, if one of the fixed-length containers is a first fixed-length container arriving at the receiving terminal on the subflow and requiring buffering, a new buffer queue for the one of the fixed-length containers in a corresponding independent space for temporary storage; otherwise, placing the one of the fixed-length containers directly in a corresponding buffer queue for the temporary storage; and performing the sorting and reassembly operation jointly when the arrival of the last fixed-length container in the same round is confirmed;
the receiver, after each round of the parallel transmission ends, sorting out-of-sequence fixed-length containers in the corresponding buffer using the consecutive sequence numbers as a keyword, submitting the out-of-sequence fixed-length containers to an upper layer after reassembly, and feeding information back to the central controller; the receiving terminal finally clearing the corresponding buffer space to wait for a next round of the multi-subflow parallel transmission; and
the central controller notifying a transmitter that the next round of the parallel transmission is started until forwarding of an entire service data flow is completed.

6. The method according to claim 2, wherein the key information in the service request comprises: a transmitting terminal node SRC, a receiving terminal node DST, an elephant flow length B, and a maximum communication delay D.

7. The method according to claim 2, wherein a constrained multi-objective optimization algorithm is used to achieve a balance of increase and decrease of the parallel transmission delay and the sorting and reassembly delay, determine the optimal flow segmentation ratio of the current service data flow, and find the corresponding optimal forwarding path;
the constrained multi-objective optimization algorithm specifically comprises: by randomly generating M row vectors consisting of n integers with a fixed sum S as an initial population, trying different subflow division and forwarding path matching solutions in a plurality of selection, crossover, and mutation processes, controlling results acquired after a plurality of iterations to continuously approach the optimal balance of the multi-subflow parallel transmission delay and the sorting and reassembly delay, finding the optimal flow segmentation ratio and the corresponding optimal forwarding path of the current service data flow with a minimized total communication forwarding delay and a maximized network resource utilization rate of the current service data flow being key objectives, and finally determining an optimal configuration situation of a number of the fixed-length containers loaded on each virtual subflow path.

8. The method according to claim 7, wherein a processing method for a constraint specifically comprises:
defining a violation value of each individual err; computing err by err=abs(c), wherein c is a row vector satisfying c(1)=|S−Σₛ_{ᵢ}_{≠0}sᵢ|, ∀i∈{1, 2, . . . , n}, S represents a total number of the fixed-length containers after the service data flow is segmented, sᵢ represents a number of the fixed-length containers transmitted by each available subflow, and n is a number of subflows available for data forwarding from the transmitter to the receiver in the network; if an individual does not accord with a constraint condition, a constraint violation value is an absolute value of a true constraint function value; if the individual accords with the constraint condition, the constraint violation value is 0; normalizing the constraint violation value to give a constraint violation degree, wherein a value range of the constraint violation degree is [0,1]; in a multi-objective optimization evolution algorithm, classifying feasible solutions and infeasible solutions using the constraint violation degree as a criterion, wherein individuals with a constraint violation degree of 0 correspond to one of the feasible solutions, and individuals without a constraint violation degree of 0 correspond to one of the infeasible solutions.

9. The method according to claim 3, wherein a process of the transmitter segmenting the service data flow requesting communication forwarding comprises:
the transmitting terminal node SRC first delivering to the central controller service request information that comprises a data flow F waiting for communication forwarding, F being defined as a quaternion F≡ [symbol] SRC, DST, B, D [symbol] , wherein SRC and DST respectively represent the transmitting terminal node and the receiving terminal node of the data flow F, B∈N* represents a length of the data flow, and D∈R⁺ is an acceptable maximum communication forwarding time of the data flow; and
the transmitting terminal node SRC segmenting raw data of the data flow F before distribution, placing the data packet sequentially into a plurality of fixed-length containers with the same length as per the positional sequence in an original data flow for later use; switching to a next fixed-length container for placing one of the data packets when a current fixed-length container is full or the remaining space is insufficient for placing a complete data packet; sequentially allocating the consecutive sequence numbers as the unique identifier to the fixed-length containers; and setting in advance the preset length of the fixed-length container to L, satisfying a condition L∈N*.

10. The method according to claim 3, wherein a specific implementation of distributing in rounds the segmented fixed-length containers to the corresponding subflows to prepare for the parallel transmission comprises:
arranging the fixed-length containers to perform the multi-subflow parallel transmission according to a flow segmentation ratio in the configuration information by using the buffer C_{buffer} at the receiving terminal as a reference indicator of the total number of the fixed-length containers in each round of transmission, on the premise that the buffer can accommodate the fixed-length containers, and computing the total number of transmitted data packets in each round using the following formula C_{rounds}; wherein
$$m ( 1 + ⌈ \frac{{s}_{2}}{{s}_{1}} ⌉ + … + ⌈ \frac{{s}_{n}}{{s}_{1}} ⌉ ) \leq {C}_{buffer} \leq ( m + 1 ) ( 1 + ⌈ \frac{{s}_{2}}{{s}_{1}} ⌉ + … + ⌈ \frac{{s}_{n}}{{s}_{1}} ⌉ ) ;$$
$$⌈ \frac{{C}_{buffer}}{1 + ⌈ \frac{{s}_{2}}{{s}_{1}} ⌉ + … + ⌈ \frac{{s}_{n}}{{s}_{1}} ⌉} - 1 ⌉ \leq m \leq ⌊ \frac{{C}_{buffer}}{1 + ⌈ \frac{{s}_{2}}{{s}_{1}} ⌉ + … + ⌈ \frac{{s}_{n}}{{s}_{1}} ⌉} ⌋ ;$$
$${C}_{rounds} = m ( 1 + ⌈ \frac{{s}_{2}}{{s}_{1}} ⌉ + … + ⌈ \frac{{s}_{n}}{{s}_{1}} ⌉ ) ;$$
sᵢ, i∈{1, 2, . . . , n} represents a number of the segmented fixed-length containers transmitted by each available subflow, n is a number of subflows available for forwarding data from the transmitter to the receiver in a network, and m is a positive integer variable;
the transmitting terminal node determining an optimal load situation of each subflow in each round based on the configuration information issued by the central controller and C_{rounds}, distributing in rounds the segmented fixed-length containers to the corresponding subflows, and preparing for a subsequently mapping to the physical network for the multi-subflow parallel transmission.
